(19) United States
(12) Patent Application Publication
(10) Pub. No.: US 2016/0179284 A1
(43) Pub. Date: Jun. 23, 2016

(54) ALTERATION OF INPUT DEVICE OPERATIONS BASED ON ACCELERATION

(71) Applicant: Intel Corporation, Santa Clara, CA (US)

(72) Inventor: Steven McGowan, Portland, OR (US)

(73) Assignee: INTEL CORPORATION, Santa Clara, CA (US)

(21) Appl. No.: 14/582,137

(22) Filed: Dec. 23, 2014

(51) Int. Cl. G06F 3/041; G09G 5/18

(52) U.S. Cl. CPC G06F 3/0418; G09G 5/18

(57) ABSTRACT

Techniques related to fumble protection. The techniques may include an apparatus having one or more modules having logic, at least partially comprising hardware logic. A detection module is configured to detect an acceleration associated with the apparatus. A comparison module is configured to compare the acceleration to a signature. An alteration module may also be included in techniques herein described. The alteration module may alter operation of at least one input device associated with the apparatus for a duration of the acceleration based on the acceleration comparison.

### TECHNICAL FIELD

This disclosure relates generally to techniques for alteration of an operation of an input device. More specifically, alteration of the operation of an input device may be based on a detected acceleration.

### BACKGROUND ART

Computing devices can include a number of input devices which users may use to operate the device. Computing devices also include a number of detectors that can detect conditions of the devices use, including in some examples, detection of the position and movement of a device.

### BRIEF DESCRIPTION OF THE DRAWINGS

FIG. 1 is a diagram illustrating an example of a computing device to implement fumble protection techniques discussed herein;

FIG. 2 is a block diagram of an example method for fumble protection;

FIG. 3 is a block diagram illustrating an example method for altering the operation of an input device;

FIG. 4 is a block diagram illustrating an example of a tangible, machine-readable medium for implementing input device alteration; and

FIG. 5 is a diagram illustrating an example of an apparatus implementing fumble protection.

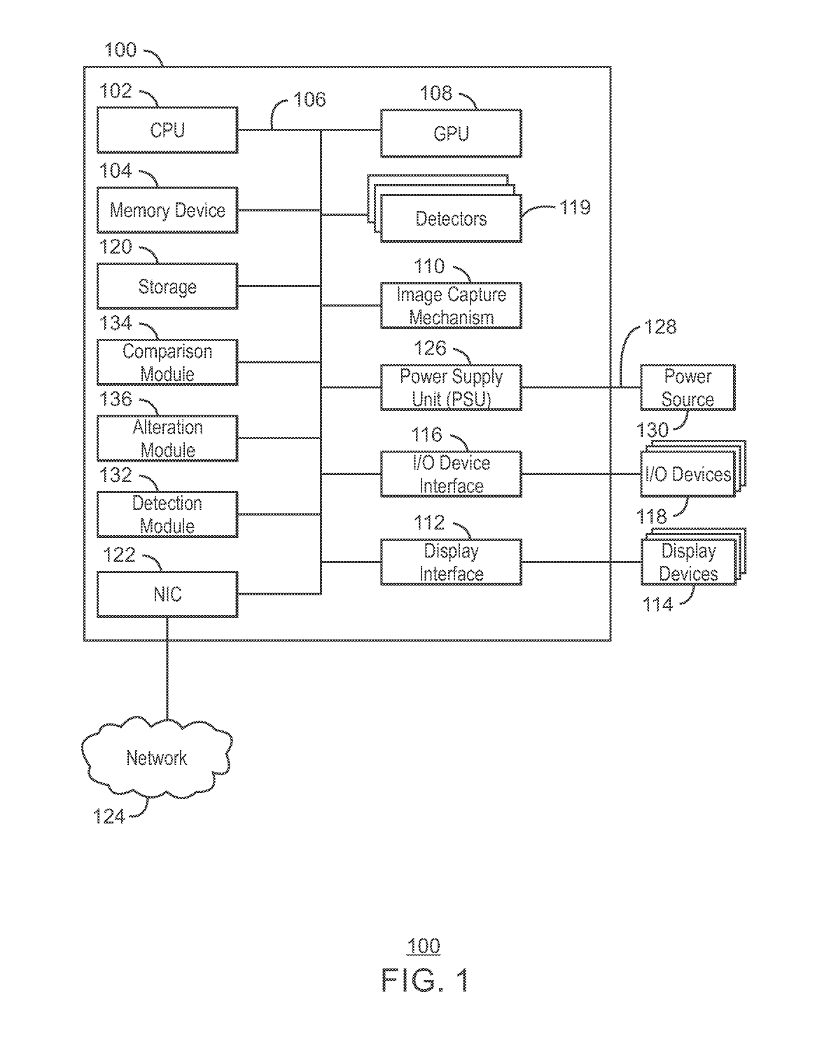

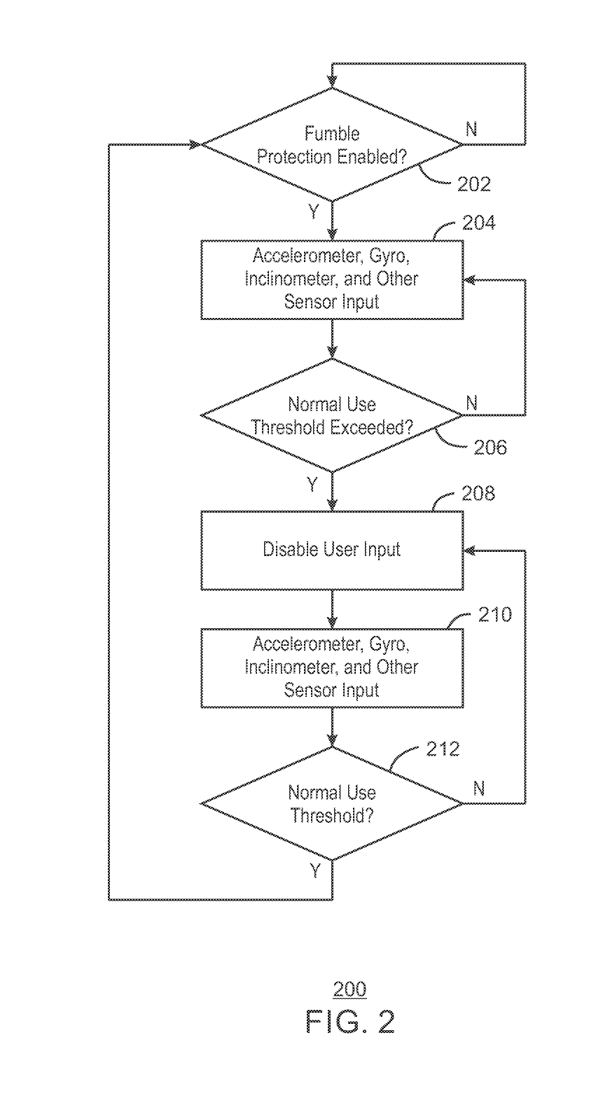

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The present disclosure relates generally to techniques for implementing fumble protection. A computing device can be handheld or at least handled by a user. Some computing devices such as cell phones, tablets, or wearable computers are nearly exclusively used through the direct handling by a user. However, direct handling by a user can result in a device being fumbled, dropped, mishandled, or bobbled. In any of those or similar circumstances a user may attempt to regain control of a device in order to operate it. In the process of regaining fully normal function of a computing device, a user may generate unintended input to the device through any of the devices input sensors. In some examples, this unintended input could include accidental or misplaced touching of a touch screen input, or in some cases, unintended visual or audible input. In examples of an unintended user touch input, the unintended touch may affect the operation of a the computing device in a number of ways including through the user's unintended manipulation of a displayed button, closing of a running program, opening of closed program, initiation of an unintended phone call, terminating an existing phone call, and the like.

The techniques described herein include detecting acceleration, video, audio, or other input that is compared to an input signature potentially associated with accidental movement. In some cases, other conditions, such as ambient light, time of day, location, and the like, may be used to verify that a detected input is or is not associated with a given accidental movement signature. For example, an acceleration may be detected potentially indicating that the computing device is being fumbled. In this scenario, the computing device may initiate a facial recognition module to determine whether an associated user is facing the mobile device for an extended period of time, in which case, the detected acceleration may be determined not to be associated with an acceleration signature indicating a fumble.

In some examples, the detection of the acceleration or the condition that indicates fumbling will enable the device to ignore user input for the duration of the detected acceleration or condition. One means for accomplishing this includes the alteration of the operation of an input device, for example a touch screen, until the detected acceleration stops.

In some examples, an acceleration may be detected. In other cases, a detected acceleration may not be enough to indicate fumbling. In such cases, one or several axes of detected accelerations or conditions may be matched to a signature that corresponds to a data set for a particular situation. For example, a signature may correspond to a stored profile of a pattern of accelerations that correspond to a drop of the device, or general mishandling of the device. However, many signatures corresponding to uses outside normal use may be used to match with detected accelerations and conditions in order to determine when an alteration should be made to the operation of an input device. Further examples of these implementations are shown in the examples below.

The detection, comparison, and alteration discussed above and in more detail below may be referred to herein as “fumble protection.” However, the techniques described herein are not limited to fumbling per se, and may be used to detect motion that is potentially unintended, accidental, or otherwise unwanted at a computing device, such as handheld mobile device. For instance a signature may be used to detect that a device is in a user's pocket and disable input to prevent unwanted dialing.

FIG. 1 is a diagram illustrating an example of a computing device 100 to implement the fumble protection techniques discussed herein. The computing device 100 may be, for example, a laptop computer, desktop computer, ultrabook, tablet computer, mobile device, wearable device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102.

The computing device 100 may also include a graphics processing unit (GPU) 108. As shown, the CPU 102 may be coupled through the bus 106 to the GPU 108. The GPU 108 may be configured to perform any number of graphics functions and actions within the computing device 100. For example, the GPU 108 may be configured to render or manipulate graphics images, graphics frames, videos, or the like, to be displayed to a user of the computing device 100.

The memory device 104 can include random access memory (RAM), read only memory (ROM), flash memory, or any other suitable memory systems. For example, the memory device 104 may include dynamic random access memory (DRAM). The computing device 100 includes an image capture mechanism 110. In some examples, the image capture mechanism 110 is a camera, stereoscopic camera, scanner, infrared sensor, or the like.

The CPU 102 may be linked through the bus 106 to a display interface 112 configured to connect the computing device 100 to one or more display devices 114. The display device(s) 114 may include a display screen that is a built-in component of the computing device 100. Examples of such a computing device include mobile computing devices, such as cell phones, tablets, 2-in-1 computers, notebook computers or the like. The display devices 114 may also include a computer monitor, television, or projector, among others, that is externally connected to the computing device 100. In some cases, the display devices 114 may be head-mounted display devices having a display capacity via projection, digital display, filtering incoming light, and the like.

The CPU 102 may also be connected through the bus 106 to an input/output (I/O) device interface 116 configured to connect the computing device 100 to one or more I/O devices 118. The I/O devices 118 may include, for example, a keyboard and a pointing device, wherein the pointing device may include a touchpad or a touchscreen, among others. In some cases, the I/O devices 118 may include audio capture devices, such as one or more microphones. In some cases, the I/O devices 118 may include image capture devices, such as the image capture mechanism 110, and the like. The I/O devices 118 may be built-in components of the computing device 100, or may be devices that are externally connected to the computing device 100. In some cases, the I/O devices 118 are touchscreen devices integrated within a display device, such as in one or more of the display devices 114.

The computing device 100 may include condition detectors 119. As discussed above, one or more of the condition detectors 119 may be configured to detect acceleration. The condition detectors may include accelerometers, gyroscopes, inclinometers, ambient light sensors, global location services, cameras, such as the image capture mechanism 110, and the like.

The computing device 100 may also include a storage device 120. The storage device 120 is a physical memory such as a hard drive, an optical drive, a thumb drive, an array of drives, or any combinations thereof. The storage device 120 may also include remote storage drives. The computing device 100 may also include a network interface controller (NIC) 122 may be configured to connect the computing device 100 through the bus 106 to a network 124. The network 124 may be a wide area network (WAN), local area network (LAN), or the Internet, among others.

The computing device 100 and each of its components may be powered by a power supply unit (PSU) 126. The CPU 102 may be coupled to the PSU through the bus 106 which may communicate control signals or status signals between then CPU 102 and the PSU 126. The PSU 126 is further coupled through a power source connector 128 to a power source 130. The power source 130 provides electrical current to the PSU 126 through the power source connector 128. A power source connector can include conducting wires, plates or any other means of transmitting power from a power source to the PSU.

The computing device 100 may also include one or more modules such as a detection module 132, a comparison module 134, and an alteration module 136. In some cases, the modules 132, 134, and 136 may be implemented as logic, at least partially comprising hardware logic. In other cases, the modules 132, 134, and 136 may be implemented as a portion of software stored in the storage device 104, as software or firmware instructions of a display driver associated with the display interface 112, as software carried out by the GPU 108, the processing device 102, any other suitable processing device, or any combination thereof. In yet other cases, the modules 132, 134, and 136 may be implemented as electronic logic, at least partially comprising hardware logic, to be carried out by electronic circuitry, circuitry to be carried out by an integrated circuit, and the like. The modules 132, 134, and 136 may be configured to operate independently, in parallel, distributed, or as a part of a broader process. In yet other cases, the modules 132, 134, and 136 may be implemented as a combination of software, firmware, hardware logic, and the like.

The detection module 132 may be configured to detect an acceleration associated with the computing device 100. The comparison module 134 may compare the acceleration to a signature, such as an acceleration profile that has previously been stored in the storage 120 as well. In some examples, the modules 132, 134, and 136 may be integrated in a sensor hub that simultaneously receives information from at least one I/O device 118. The modules 132, 134, and 136 may also include firmware to interpret or compare detected accelerations to stored signatures.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

FIG. 2 is a block diagram of an example method 200 for fumble protection. The method begins at block 202 where it is determined whether fumble protection is enabled or not. If it is not, the method will continue to determine whether or not fumble protection is enabled before proceeding. If yes, fumble protection is enabled, the method may continue to block 204.

At block 204, a device may gather sensor and detection input from any number of I/O devices including in some examples an accelerometer, gyroscope, inclinometer. This data may be stored or immediately used in the next step of the method.

At block 206, the detected sensor input may be compared to a threshold, a signature, or a stored condition threshold to determine if the detected sensor input matches normal device use or not. In some examples, when a device is fumbled, a sensor may detect an acceleration that is beyond an acceleration threshold for normal use. If a threshold is passed, the method may proceed to block 208.

At block 208, the device may disable user input device. In some examples user input may be obtained by any device that a user may touch or access. This can include touch screens, portions of touch screens, and also keys, buttons, cameras, microphones, or other areas of user input.

At block 210, detection sensors including, in some examples, accelerometers, gyroscopes, inclinometers, and other suitable sensors may continue to gather sensor input. This information may be used to continually inform a device on the state of the device even though the user input devices are disabled.

At block 212, a determination is made again if the detected input from the sensors are within a normal use threshold. In some examples, once normal use is once again regained, user input will no longer be disabled and the method will restart at block 202 or block 204 of the state of fumble protection has not changed. In some embodiments, if Fumble Protection is disabled at any point in this proposed method, then the method may proceed to block 202. However, if a fumble is still detected based on the detected sensor input, then the process may continue at block 208 where user input will either be deactivated, or remain deactivated. In some cases, if a signature is falsely detected by a fumble condition, then the method may exit the loop beginning at block 208 and return to block 204.

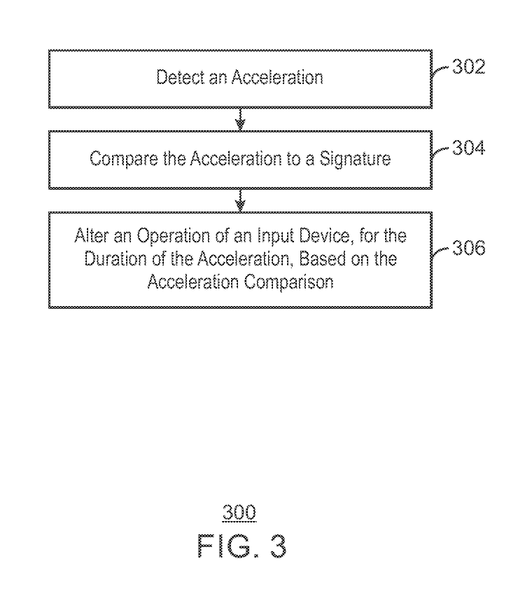

FIG. 3 is a block diagram illustrating an example method 300 for altering the operation of an input device. The example method 300 may being at block 302, however, other method progressions and starting points are possible.

At block 302, an acceleration associated with the apparatus may be detected by a detection module. This may be the result of a user attempting to remove the apparatus from the user's pocket, by mishandling the device, or by simply misusing the apparatus.

At block 304, a comparison module may compare the acceleration to a signature. The signature may include an acceleration threshold, a condition threshold, or a profile of sensor data specifically associated with a particular action of the device. Upon detecting a signature, the comparison module may invoke input from other devices (e.g. cameras, light sensors, etc.) to further qualify the decision as to whether the original signature should result in a transition to 306.

At block 306, an alteration module may alter the operation of at least one input device associated with the apparatus, for the duration of the acceleration, based on the acceleration comparison. In some embodiments, the altering of an input device includes turning off an input device altogether, but may also include simply no longer receiving input from the device or filtering specific input from the device.

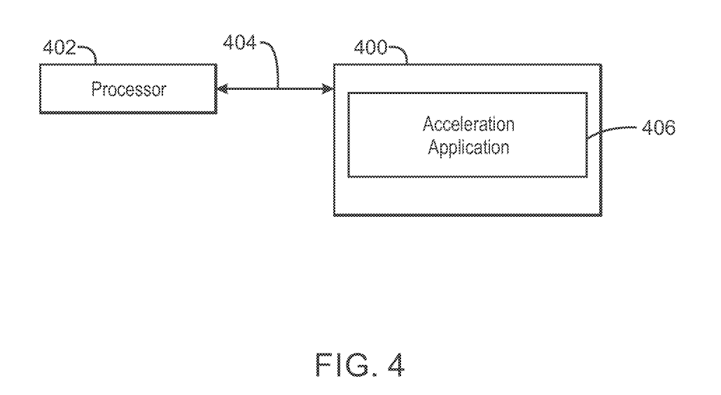

FIG. 4 is a block diagram illustrating an example of a tangible, machine-readable medium 400 for implementing input device alteration. The machine-readable medium may be connected to a processor 402 by a bus 404. The processor 402 may be a single core processor, a multi-core processor, a computing cluster, or any number of other configurations. The bus 404 may link and allow the transmission of data between the processor 402 and the machine-readable medium 400. The machine-readable medium 400 may be a non-transitory machine-readable medium, a storage device configured to store executable instructions, or any combination thereof. In any case, the machine-readable medium 400 is not configured as a wave or signal.

The machine-readable medium 400 may include an acceleration application 406. The acceleration application 406 may be configured to detect an acceleration associated with an apparatus, such as a computing device. The acceleration application 406 may be configured to compare the detected acceleration to a signature. The acceleration application 406 may be configured to alter operation of at least one input device associated with the apparatus, for the duration of the acceleration, based on the acceleration comparison.

In accordance with embodiments discussed herein, the acceleration application 406 may be configured to detect any “atypical device motion” through the use of detecting acceleration profiles that exceed normal usage acceleration profiles. These detections may lead to momentary disabling an input device to avoid unwanted, unexpected, or otherwise unintended input. A user may be given the option to disable the fumble protection offered by the machine-readable medium 400, which may be useful if the user's typical activities may be mistaken as fumbling. In some cases, fumble event detection may utilize an adaptive fumble detection algorithm, which may tailor the fumble thresholds to specific physical motion patterns of a user, thus allowing a broader or narrower set of “normal” conditions before fumble detection begins operation.

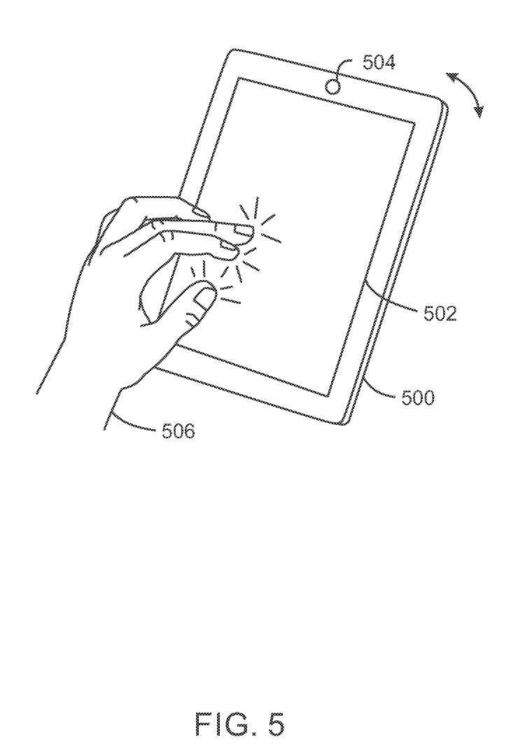

FIG. 5 is a diagram illustrating an example of an apparatus 500 implementing fumble protection. The apparatus 500 may be a tablet, phone, or other mobile device. The apparatus 500 may include a touch screen input device 502, as well as a camera input device 504. The apparatus 500 may be operated by a user 506 who may occasionally fumble the apparatus 500 and unintentionally provide input to the touch screen input device 502.

In some examples, the apparatus 500 may detect the fumbling of the apparatus 500 based on matching detected accelerations or conditions to a signature associated with a particular movement. In some examples, the apparatus 500 may detect the movement and deactivate the touch screen input 502. In some examples, the apparatus 500 may also deactivate other input devices such as camera input devices 504 or microphones (not shown). These deactivations may be useful when running certain applications such as video messaging applications that would be very disrupted by an outburst by a user 506 who fumbled the apparatus 500.

The apparatus 500 may include a detection module, such as the detection module 132 of FIG. 1. The acceleration may be considered a first condition. In some examples, an apparatus 500 may include a second detection module to detect a second condition in addition to the acceleration. A comparison module, such as the comparison module 134, compares a detection condition to the signature. The apparatus 500 may also include an alteration module, such as the alteration module 136. The alteration module alters operation of the at least one input device associated with the apparatus, for the duration of the condition, based on the condition comparison. In some examples the condition can include any detected information including acceleration, light detected from a camera, data from a gyroscope, data from and inclinometer, or other input from other suitable I/O devices.

In some examples, the second detection module is not receiving power and is not operating until a request is made by the comparison module 408 to verify a comparison made to the signature. It may be understood that the verification may be requested if an accurate comparison cannot be made as fumbling, or when additional accuracy and verification is desired by a user 506.

In some examples, the condition to be detected is unique to a user 506 associated with the apparatus 500. In some cases, this could include detecting a finger print detected by an I/O device, or also a picture of a user's face captured by a camera input device 504. In some examples, the signature may include at least one of a threshold acceleration, a threshold condition, and a profile to compare to data generated by a detection module 406, wherein the profile is associated with a specific use, a location, or a movement of the apparatus. In some examples, the threshold condition may be a certain light level detected by the camera input device 504.

In some examples, the alteration module 136 of FIG. 1 alters not only one input device to prevent user input, but also may simultaneously alter images to be displayed at the apparatus 500. For example, if a fumble is detected, the display may be temporarily turned off, or shown to be in a fumbled state rather than showing icons or buttons to press. In this example, a user 506 may be less confused if attempting to operate the apparatus 500 via a temporarily disabled touch screen input device 502. And if sensitive information was on the screen, it will not be visible if the device lands on the ground. In some examples, the input device may be altered to prevent a user input by deactivating an input receiver of the input device. This example may be more useful with power intensive input receivers that may be shut down momentarily when not in use to save power consumption of the apparatus 500.

In some examples, multiple conditions and accelerations may be detected and compared to signatures at the same time. The combination of additional profiles may improve the comparison performed by the comparison module 136. The use of more than one acceleration or more than one condition to may aid in more accurately or quickly identifying the particular scenario for the apparatus.

### Example 1

Some examples relate to an apparatus, including modules having logic, at least partially comprising hardware logic. In some examples, the modules may include a detection module to detect an acceleration associated with the apparatus as well as a comparison module to compare the acceleration to a signature. In some examples, an alteration module may be included to alter operation of at least one input device associated with the apparatus for a duration of the acceleration based on the acceleration comparison. In some cases, the detected acceleration includes a first condition, the apparatus further including a second detection module to detect a second condition, wherein the comparison module compares a detected second condition to the signature, and the alteration module alters operation of the at least one input device associated with the apparatus, for the duration of the second condition, based on the condition comparison. In some examples, the second detection module is not receiving power and is not operating until a request is made by the comparison module to verify the comparison of the acceleration to the signature. In some examples, the condition to be detected is unique to a user associated with the apparatus. In some cases, the signature includes at least one of a threshold acceleration, a threshold condition, and a profile associated with a specific use of the apparatus, a location of the apparatus, a movement of the apparatus or any combination thereof. In some examples, the alteration module alters the at least one input device to prevent a user input and to alter image content displayed at the apparatus. In some examples, the at least one input device are altered to prevent a user input by deactivating an input receiver. A second detection module may also be included to detect a condition at the same time as the detection by the first detection module of the acceleration. In this example, the comparison module uses at least one of the detected condition and the detected acceleration to compare with the signature, and wherein the alteration module alters the operation of the at least one input device based on at least one of the detected condition and detected acceleration. Some examples may also include detecting a second condition occurring at the same time as first condition as well as verifying whether the first condition is associated with the signature based on the detection of the first condition and the second condition. Some examples include the at least one input device comprises a touch screen associated with the apparatus, and altering the operation comprises disabling a touch sensing functionality of the touch screen. In some cases, the acceleration may be associated with a movement of the apparatus during which inputs are not intended to be received at the apparatus.

### Example 2

Some examples relate to a method to alter the operation of input devices of an apparatus including detecting an acceleration associated with the apparatus, comparing the acceleration to a signature, and altering an operation of at least one input device associated with the apparatus for a duration of the acceleration based on the acceleration comparison. Other examples may relate to detecting a condition, comparing the detected condition to the signature, and altering operation of the at least one input device associated with the apparatus, for a duration of the condition, based on the condition comparison. In some examples, detecting the condition may be triggered by a request is made by the comparison module to verify the comparison of acceleration to the signature. In some example, the condition to be detected is unique to a user associated with the apparatus. In some examples, the signature includes at least one of a threshold acceleration, a threshold condition, and a profile associated with a specific use of the apparatus, a location of the apparatus, a movement of the apparatus, or any combination thereof. In some examples the altering includes deactivating an input receiver of the input device to prevent user input for the duration of the acceleration. In some examples, the at least one input device comprises a touch screen associated with the apparatus, and wherein deactivating the input receiver comprises disabling a touch sensing receiver of the touch screen for the duration of the acceleration. In some examples, the input device comprises an image capture device, wherein deactivating includes disabling the image capture device for the duration of the acceleration. In some examples, the detected acceleration comprises a first condition, the method further includes detecting a second condition occurring at the same time as first condition, verifying whether the first condition is associated with the signature based on the detection of the first condition and the second condition. In some cases, the signature includes a movement profile associated with a movement of the apparatus during which inputs are not intended to be received at the apparatus.

### Example 3

In some examples a tangible, computer-readable medium may store instructions that when executed by a processor cause an apparatus to detect an acceleration associated with the apparatus, compare the acceleration to a signature, alter an operation of at least one input device associated with the apparatus for the duration of the acceleration based on the acceleration comparison. In some examples, the detected acceleration comprises a first condition, further comprising instructions that when executed by a processor cause the apparatus to detect a second condition, compare the detected second condition to the signature, and alter operation of the at least one input device associated with the apparatus, for the duration of the second condition, based on the condition comparison. In some cases, the second condition does not occur until a request is made by the comparison module to verify the comparison made to the signature. In some examples, the condition to be detected is unique to a user associated with the apparatus. In some examples, the signature comprises at least one of a threshold acceleration, a threshold condition, a profile associated with a specific use of the apparatus, a location of the apparatus, a movement of the apparatus, or any combination thereof.

An embodiment is an implementation or example. Reference in the specification to “an embodiment”, “one embodiment”, “some embodiments”, “various embodiments,” or “other embodiments” means that a particular feature, structure, or characteristic described in connection with the embodiments is included in at least some embodiments, but not necessarily all embodiments, of the present techniques. The various appearances of “an embodiment”, “one embodiment” or “some embodiments” are not necessarily all referring to the same embodiments.

Program code may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Not all components, features, structures, characteristics, etc. described and illustrated herein may be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein may not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the machine-readable medium described herein. Furthermore, although flow diagrams and/or state diagrams may have been used herein to describe embodiments, the techniques are not limited to those diagrams or to corresponding descriptions herein. For example, flow may not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus, comprising modules having logic, at least partially comprising hardware logic, the modules comprising:
a detection module to detect an acceleration associated with the apparatus;
a comparison module to compare the acceleration to a signature;
an alteration module to alter operation of at least one input device associated with the apparatus for a duration of the acceleration based on the acceleration comparison.

2. The apparatus of claim 1, wherein the detected acceleration comprises a first condition, the apparatus further comprising a second detection module to detect a second condition, wherein the comparison module compares a detected second condition to the signature, and the alteration module alters operation of the at least one input device associated with the apparatus, for the duration of the second condition, based on the condition comparison.

3. The apparatus of claim 2, wherein the second detection module is not receiving power and is not operating until a request is made by the comparison module to verify the comparison of the acceleration to the signature.

4. The apparatus of claim 2, wherein the condition to be detected is unique to a user associated with the apparatus.

5. The apparatus of claim 1, wherein the signature comprises at least one of:
a threshold acceleration;
a threshold condition; and
a profile associated with:
a specific use of the apparatus;
a location of the apparatus;
a movement of the apparatus; or
any combination thereof.

6. The apparatus of claim 1, wherein the alteration module alters the at least one input device to prevent a user input and to alter image content displayed at the apparatus.

7. The apparatus of claim 1, wherein the at least one input device are altered to prevent a user input by deactivating an input receiver.

8. The apparatus of claim 1, comprising:
a second detection module to detect a condition at the same time as the detection by the first detection module of the acceleration;
wherein the comparison module uses at least one of the detected condition and the detected acceleration to compare with the signature; and
wherein the alteration module alters the operation of the at least one input device based on at least one of the detected condition and detected acceleration.
detecting a second condition occurring at the same time as first condition;
verifying whether the first condition is associated with the signature based on the detection of the first condition and the second condition.

9. The apparatus of claim 1, wherein:
the at least one input device comprises a touch screen associated with the apparatus; and
altering the operation comprises disabling a touch sensing functionality of the touch screen.

10. The apparatus of claim 1, wherein the acceleration is associated with a movement of the apparatus during which inputs are not intended to be received at the apparatus.

11. A method to alter the operation of input devices of an apparatus comprising:
detecting an acceleration associated with the apparatus;
comparing the acceleration to a signature;
altering an operation of at least one input device associated with the apparatus for a duration of the acceleration based on the acceleration comparison.

12. The method of claim 11, comprising:
detecting a condition;
comparing the detected condition to the signature; and
altering operation of the at least one input device associated with the apparatus, for a duration of the condition, based on the condition comparison.

13. The method of claim 12, wherein detecting the condition is triggered by a request is made by the comparison module to verify the comparison of acceleration to the signature.

14. The method of claim 12, wherein the condition to be detected is unique to a user associated with the apparatus.

15. The method of claim 11, wherein the signature comprises at least one of:
a threshold acceleration;
a threshold condition; and
a profile associated with:
a specific use of the apparatus;
a location of the apparatus;
a movement of the apparatus; or
any combination thereof.

16. The method of claim 11, wherein the altering comprises deactivating an input receiver of the input device to prevent user input for the duration of the acceleration.

17. The method of claim 16, wherein the at least one input device comprises a touch screen associated with the apparatus, and wherein deactivating the input receiver comprises disabling a touch sensing receiver of the touch screen for the duration of the acceleration.

18. The method of claim 16, wherein the input device comprises an image capture device, wherein deactivating comprises disabling the image capture device for the duration of the acceleration.

19. The method of claim 11, wherein the detected acceleration comprises a first condition, the method further comprising:
detecting a second condition occurring at the same time as first condition;
verifying whether the first condition is associated with the signature based on the detection of the first condition and the second condition.

20. The method of claim 11, wherein the signature comprises a movement profile associated with a movement of the apparatus during which inputs are not intended to be received at the apparatus.

21. A tangible, computer-readable medium to store instructions that when executed by a processor cause an apparatus to:
detect an acceleration associated with the apparatus;
compare the acceleration to a signature;
alter an operation of at least one input device associated with the apparatus for the duration of the acceleration based on the acceleration comparison.

22. The tangible, computer-readable medium of claim 21, wherein the detected acceleration comprises a first condition, further comprising instructions that when executed by a processor cause the apparatus to:
detect a second condition;
compare the detected second condition to the signature; and
alter operation of the at least one input device associated with the apparatus, for the duration of the second condition, based on the condition comparison.

23. The tangible, computer-readable medium of claim 22, wherein detecting the second condition does not occur until a request is made by the comparison module to verify the comparison made to the signature.

24. The tangible, computer-readable medium of claim 21, wherein the condition to be detected is unique to a user associated with the apparatus.

25. The tangible, computer-readable medium of claim 21, wherein the signature comprises at least one of:
a threshold acceleration;
a threshold condition; and
a profile associated with:
a specific use of the apparatus;
a location of the apparatus;
a movement of the apparatus; or
any combination thereof.
